(19) United States
(12) Patent Application Publication
(10) Pub. No.: US 2014/0375151 A1
(43) Pub. Date: Dec. 25, 2014

(54) STEPPER MOTOR WITH INTEGRATED BRAKE AND DRIVE CIRCUIT

(71) Applicant: Johnson Electric S.A., Murten (CH)

(72) Inventor: Miha Furlan, Bern (CH)

(21) Appl. No.: 14/309,359

(22) Filed: Jun. 19, 2014

(30) Foreign Application Priority Data
Jun. 20, 2013 (GB) 1311035.8

(51) Int. Cl. H02K 7/102; H02K 37/14

(52) U.S. Cl. CPC H02K 7/1025; H02K 37/14
USPC 310/49.54

(57) ABSTRACT

A stepper motor has a rotor, a stator and an electro-magnetic brake. The rotor has permanent magnet rotor poles. The stator has a stator winding with at least 2 phases. The brake is electrically connected to the phases of the stator winding and arranged to be released when at least one of the phases is energized.

### CROSS REFERENCE TO RELATED APPLICATIONS

This non-provisional patent application claims priority under 35 U.S.C. §119(a) from Patent Application No. 1311035.8 filed in the United Kingdom on Jun. 20, 2013, the entire contents of which are hereby incorporated by reference.

### FIELD OF THE INVENTION

This invention relates to a stepper motor and in particular, to a stepper motor having an integrated brake.

### BACKGROUND OF THE INVENTION

Stepper motors are used in precise positioning applications. In order to temporarily hold the target position a holding torque with reduced or no electrical input power is desirable for low heat dissipation and low power consumption.

In prior art stepper motor actuators a holding torque is usually realized by means of mechanical friction such as a self locking transmission gear with low efficiency, or magnetic detent torque. These mechanisms reduce the available output torque or introduce electromagnetic torque ripple with negative consequences for low-vibration dynamic operation. Therefore, they are in conflict with the requirement of an efficient electromagnetic actuator system as currently demanded for low power or energy efficient, environmentally friendly products.

The combination of an electric motor with an electromagnetic or solenoid brake is known. However, driving of the brake requires additional electronics and control lines, adding cost and complexity to the actuator. Stepper motors with mechanical brakes are not generally known. One issue with adding an electromagnetic brake to a stepper motor is how to prevent actuation of the brake during slow stepping of the motor. This can be achieved by using a complex electronic circuitry but this makes the motor too expensive for most applications.

### SUMMARY OF THE INVENTION

Hence there is a desire for an efficient stepper motor with an integrated brake which is actuated when the stepper motor is powered off using a simple control circuit.

This is achieved in the present invention by using a conventional stepper motor to which a power-off electromagnetic brake is coupled. The electric lines powering the motor phases (two per phase) are also fed to a rectifier circuit which is designed to open the solenoid brake when phase current is applied. Otherwise, the brake remains closed when no phase is excited.

Accordingly, in one aspect thereof, the present invention provides a stepper motor comprising: a rotor having permanent magnet rotor poles; a stator having a stator winding with at least 2 phases; and an electro-magnetic brake, wherein the brake is electrically connected to the phases of the stator winding and arranged to be released when at least one of the phases are energized.

Preferably, the electro-magnetic brake comprises a solenoid, a friction disc and a spring, wherein the spring urges the friction disc into contact with the rotor and the solenoid is arranged to move the friction disc out of contact with the rotor, when energized.

Preferably, a rectifier is connected to each phase of the stator winding respectively to supply power to the solenoid.

Preferably, each rectifier is connected to the corresponding phase via a resister.

Preferably, each rectifier is a full-wave rectifier.

Preferably, an output of each rectifier is a connected in parallel to the solenoid and to a capacitor connected across the solenoid.

Preferably, the number of control lines for operating the motor is equal to or less than two times the number of motor phases.

Preferably, the electronics driving the electro-magnetic brake are integrated in the motor.

Preferably, the brake provides a holding torque that is at least as high as the maximum torque produced by the motor when excited at nominal operating conditions.

Preferably, the brake, when excited, creates substantially no drag on the motor.

Embodiments of the present invention provide a stepper motor with integrated power-off solenoid brake having a simple electronics. A power-off solenoid brake is a solenoid operated brake which is holding or closed when the solenoid is not excited and free or open when the solenoid is energized.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a sectional view of a two-phase stepper motor having a solenoid brake, viewed in the de-energized condition;

FIG. 2 is a view similar to FIG. 1, with the motor in the energized condition;

FIG. 3 is a schematic diagram of a preferred electrical circuit for operating a solenoid brake on a two-phase stepper motor, in accordance with the present invention;

FIG. 4 is a graph of the drive signals feed to the stepper motor on FIG. 1, in full-step bipolar voltage bias mode;

FIG. 5 is a graph of the corresponding current response measured at the phase coils;

FIG. 6 is a graph of the current in the solenoid brake when the motor is in full-step mode;

FIG. 7 is a graph of current signals measured at the phase coils, similar to FIG. 5, when the motor is driven in micro-stepping mode; and

FIG. 8 is a graph of the current in the solenoid brake when the motor is operating in micro-stepping mode.

### DETAILED DESCRIPTION OF THE PREFERRED EMBODIMENTS

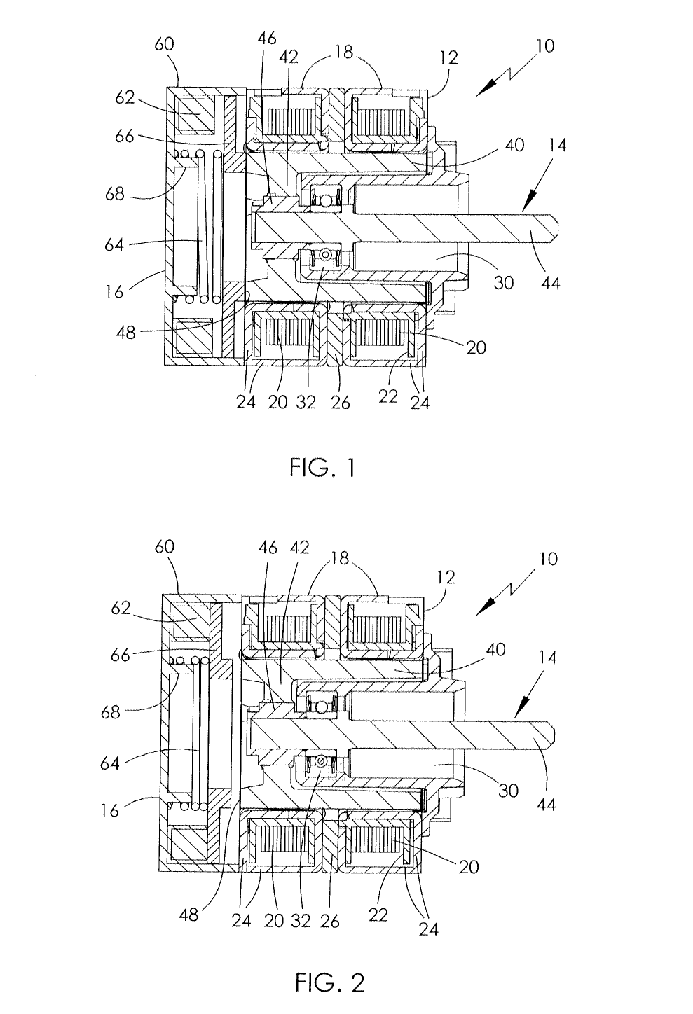

FIG. 1 is a sectional view of a two-phase stepper motor 10 with an electromagnetic brake attached to the left hand side. The stepper motor is shown in schematic form to illustrate the principle of operation of the invention. As such not all components of the motor are shown, such as motor terminals, bearings, housing and mounting structures. The stepper motor has a stator 12, a rotor 14 and the electromagnetic brake in the form of a solenoid brake 16. The stator 12 has two phase assemblies 18, each comprising a coil 20 wound on a bobbin 22 and disposed between a pair of pole plates 24. The two phase assemblies are separated axially by a spacer 26.

The phase assemblies define an internal space in which the rotor 14 is located. The rotor comprises a rotor core 40 and a shaft 44. The shaft is fixed to a hub 42 of the rotor core by a coupling 46. The rotor core is preferably a molded permanent magnet but may be of another form such as a supporting core, including the hub having a ring magnet fitted to or otherwise attached there on. The rotor is rotatably supported by a bearing 32 fitted the shaft 44 and mounted in a bearing holder 32 that extends into the void of the rotor core and forms a part of a housing or frame for the motor.

The solenoid brake 16 has a cover 60, a solenoid coil 62 fitted to the cover, a spring 64 and a friction disc 66. The friction disc is axially movable within the cover but is not permitted to rotate. The friction disc is arranged to be pressed against the rotor 14 by the spring to stop the rotor from rotating. In this example, the friction disc makes direct contact with an axial end face 48 of the rotor core 40. The spring is located within the cover 60 by a guide 68. The friction disc is magnetic and is located within the magnetic field generated by the solenoid coil when it is energized so as to be attracted to the solenoid against the urgings of the spring. Thus in use, when the solenoid in not energized and no magnetic field is being produced by the solenoid coil, the friction disc is pressed against the rotor by the spring, as shown in FIG. 1. When the solenoid is energized, as shown in FIG. 2, the magnetic field produced by the solenoid attracts the friction plate causing it to move towards the solenoid and out of contact with the rotor, allowing the rotor to rotate freely.

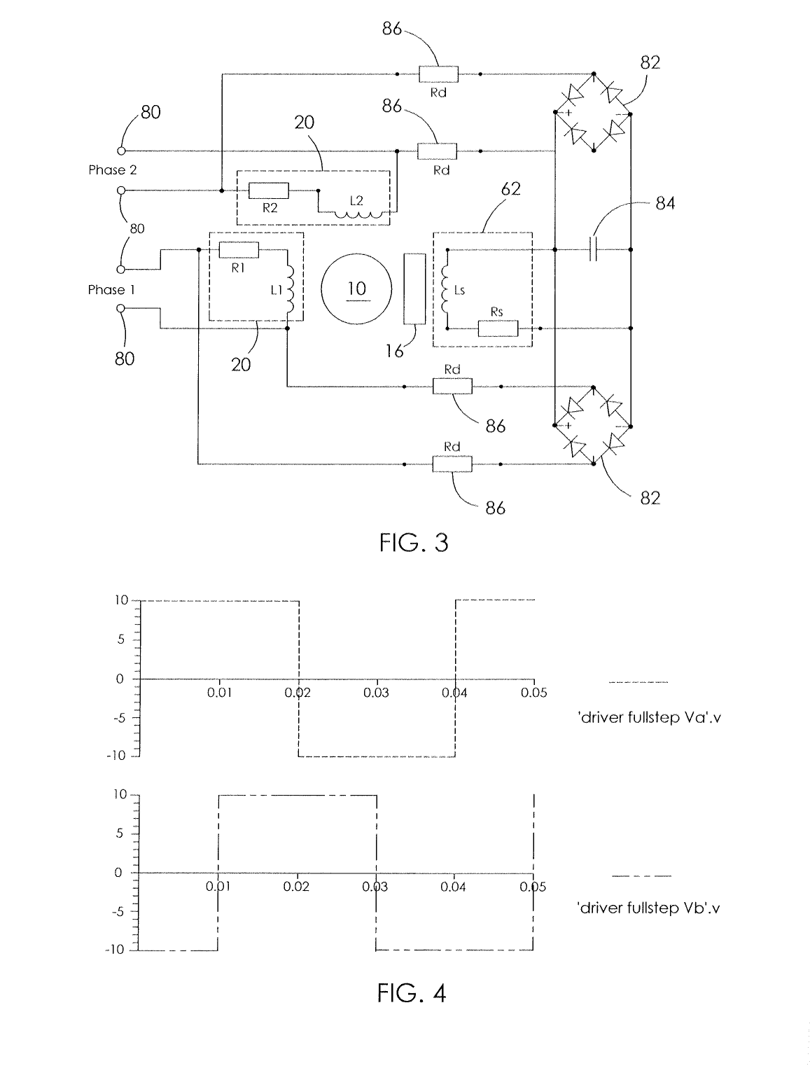

Energizing the solenoid in conjunction with energizing the phase coils of the motor will now be described, with reference to the preferred exemplary circuit diagram shown in FIG. 3 and the graphs of FIGS. 4 to 8. Power is fed to the phase coils via input terminals 80. R1 & L1 represent the 1st phase coil and R2 & L2 represent the 2nd phase coil. A takeoff feed from each phase is feed to a rectifier 82. Rectifier 82 is preferably a full wave rectifier, although other types such as a half wave rectifier may be used with differing performance. The output of each rectifier is combined and feed to the solenoid coil 62 of the solenoid brake 16, represented by Rs & Ls. Optionally, a capacitor 84 smoothes the input to the solenoid coil by reducing the current ripple. The rectifiers 82 are connected to the phase terminals via resistors 86 for decoupling or impedance matching.

FIG. 4 is a graph (voltage v time) of voltage signals Va & Vb applied to the phase inputs in full-step bipolar voltage bias mode. The voltage signals are square waves with a step frequency of 100 full steps per second, i.e. a period of 10 ms.

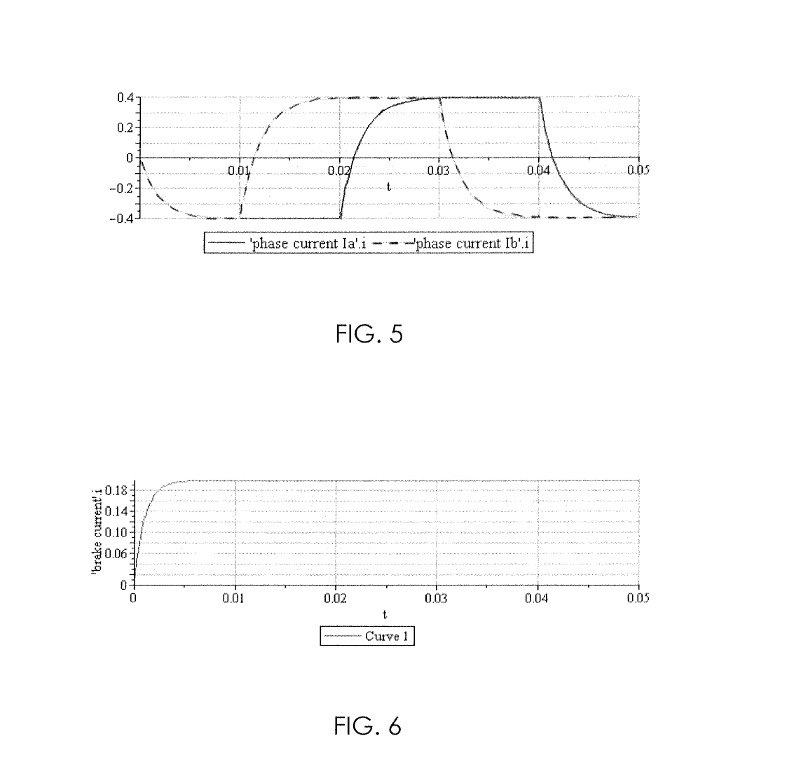

FIG. 5 is a graph (Amps v time) of the corresponding current response Ia & Ib measured at the phase coils.

FIG. 6 is a graph (Amps v time) of the corresponding current in the solenoid coil at startup of the motor, i.e. at time t=0, when the signals of FIG. 4 are applied to the motor. By choosing appropriate circuit components (inductances, resistances, capacitors) the current rise time and the dynamic response of the brake can be made sufficiently short compared to the motor speed.

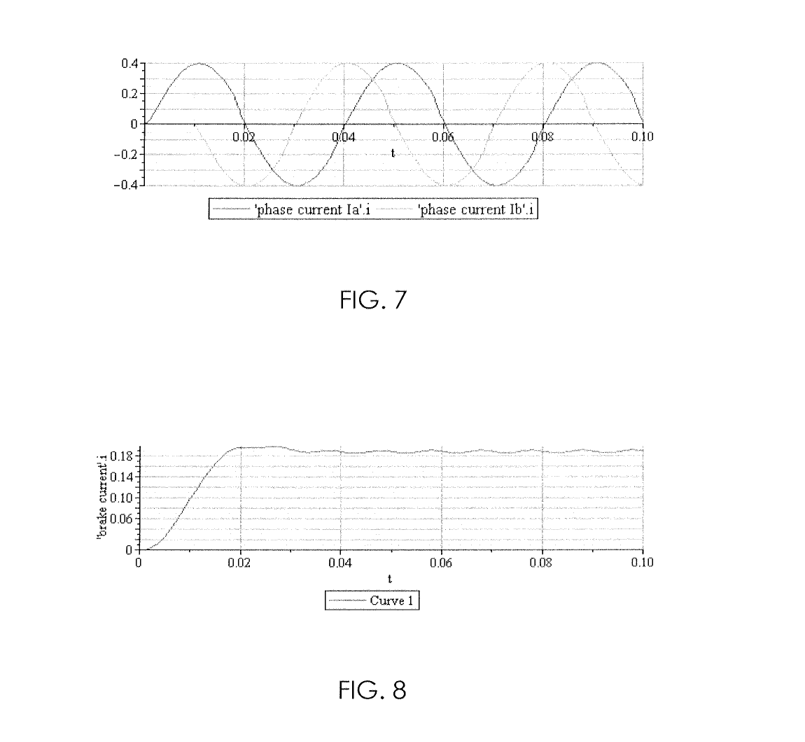

FIG. 7 is a graph of the current response, similar to the graph of FIG. 5, when the motor is being driven in micro-stepping mode (quasi-sinusoidal current). Note that the scale for the time axis has been changed and is double that of FIG. 5.

FIG. 8 is a graph, similar to the graph of FIG. 6, of the corresponding current in the solenoid coil at startup of the motor, i.e. at time t=0, when the motor is operated in micro-stepping mode as shown in FIG. 7. Again, please note the change in the scale for the time axis.

Thus the present invention provides a circuit for controlling the operation of an electromagnetic brake on a stepper motor, which is simple and cost effective.

Several important advantages may be achieved by embodiments of the present invention. These advantages include:

By having an electromagnetic brake built into the housing of the stepper motor, the motor is very compact and the motor itself is able to be free from the usual frictional features, such as the gear geometry used to increase friction to prevent back driving of the motor. This means that the overall motor efficiency can be significantly increased through the use of gear geometries with a higher efficiency, without regard to back drive. The friction type gear geometries are sensitive to temperature changes resulting in temperature related variations in maximum holding force and motor efficiency due to the varying friction. The use of low friction gears also reduces gear wear and friction heating of the gears. Thus the holding torque is stable and not dependent on temperature.

By default the unpowered stepper motor is rotationally immobile. Hence, the factory preset position does not change under strong forces and vibration, as experienced, for example, during mounting or transport. This means that less setup time is required on the production line and in field replacements.

The holding force is also customizable by adjusting the friction surface (material or shape) and the force applied by the spring.

The control of the brake is achieved in a simple manner with minimal components in a motor with multiple phases. This leads to low cost and the ability to integrate the controls into the motor housing. The simple controls also means that the motor can be treated essentially in the same manner as a motor without a brake, as no additional wiring is required to control the brake.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

For example, the invention is not limited to 2-phase motors but is applicable to any poly-phase synchronous drive.

Also, in case the parameters of the available motor and brake components can not satisfy a brake response time much faster than the motor step period (open and close should occur before movement), an initial motor excitation on the first step will allow the brake to release prior to starting the commutation sequence. This can be part of the speed ramp algorithm.

As previously mentioned, instead of full-wave rectifiers, half-wave rectifiers may be used to save space and cost, but for the price of reduced electrical power transfer (50% reduction).

1. A stepper motor comprising:
a rotor having permanent magnet rotor poles;
a stator having a stator winding with at least 2 phases; and
an electro-magnetic brake,
wherein the brake is electrically connected to the phases of the stator winding and arranged to be released when at least one of the phases are energized.

2. The stepper motor of claim 1, wherein the electro-magnetic brake comprises a solenoid, a friction disc and a spring, wherein the spring urges the friction disc into contact with the rotor and the solenoid is arranged to move the friction disc out of contact with the rotor, when energized.

3. The stepper motor of claim 2, wherein a rectifier is connected to each phase of the stator winding respectively to supply power to the solenoid.

4. The stepper motor of claim 3, wherein each rectifier is connected to the corresponding phase via a resister.

5. The stepper motor of claim 3, wherein each rectifier is a full-wave rectifier.

6. The stepper motor of claim 3, wherein an output of each rectifier is a connected in parallel to the solenoid and to a capacitor connected across the solenoid.

7. The stepper motor of claim 1, wherein the number of control lines for operating the motor is equal to or less than two times the number of motor phases.

8. The stepper motor of claim 1, wherein the electronics driving the electro-magnetic brake are integrated in the motor.

9. The stepper motor of claim 1, wherein the brake provides a holding torque that is at least as high as the maximum torque produced by the motor when excited at nominal operating conditions.

10. The stepper motor of claim 1, wherein the brake, when excited, creates substantially no drag on the motor.
